(19) United States
(12) Patent Application Publication
(10) Pub. No.: US 2004/0085267 A1
(43) Pub. Date: May 6, 2004

(54) Light emitting display device

(76) Inventor: Daniel Levine, Bellingham, WA (US)

Correspondence Address: Dr. Daniel Levine, P.O. Box 28312, Bellingham, WA, 98228, US

(21) Appl. No.: 10/285,806

(22) Filed: Nov. 4, 2002

(51) Int. Cl. G09G 3/30

(52) U.S. Cl. 345/76

(57) ABSTRACT

The present invention has been implemented in view of the lack of light emitting animated electroluminescent display devices with multiple animation configurations. A light emitting electroluminescent display device contains a design in a layered substrate which includes electroluminescence; circuitry connected to a power source carries the electric charge to a varied number of contact points which connect with the different graphic and/or text design element(s) to be illumined; there is a means for opening and closing the electrical circuit(s) that contact the different graphic and/or text design element(s) to be illumined; the electric charge can illumine any and all design element(s) in any selected simple or complex pattern such that the graphic and/or text design is animated with multiple animation configurations when the different electroluminescent graphic and/or text design element(s) is/are illumined.

### CROSS-REFERENCE TO RELATED APPLICATIONS

| | | | |
|---|---|---|---|
| 4076976 | February 1978 | Fenton | 362/104 |
| 4195431 | April 1980 | Neufeld | 40/544 |
| 4527096 | July 1985 | Kindlmann | 315/169.3 |
| 4554565 | November 1985 | Kito et al. | 503/201 |
| 4556932 | December 1985 | Lehrer et al. | 362/104 |
| 4637148 | January 1987 | Barlow | 40/1 |
| 4638409 | January 1987 | Berman | 362/103 |
| 4665342 | May 1987 | Tapp et al. | 313/505 |
| 5010665 | April 1991 | Clinkscales | 40/1.5 |
| 5055968 | October 1991 | Nishi et al. | 361/737 |
| 5111366 | May 1992 | Rife et al. | 362/31 |
| 5243504 | September 1993 | Seizer | 362/104 |
| 5413739 | May 1995 | Coleman | 252/511 |
| 5495250 | February 1996 | Ghaem et al. | 342/51 |
| 5500759 | March 1996 | Coleman | 359/270 |
| 5557208 | September 1996 | Parker | 324/435 |
| 5576078 | November 1996 | Schatz | 428/13 |
| 5709962 | May 1998 | Ray | 362/103 |
| 5825174 | October 1998 | Parker | 324/106 |
| 5872552 | February 1999 | Gordon, II et al. | 345/107 |
| 6019284 | February 2000 | Freeman et al. | 235/380 |
| 6011529 | January 2000 | Ikeda | 345/77 |
| 6034481 | March 2000 | Haynes | 315/169.3 |
| 6369793 | April 2002 | Parker | 345/107 |
| 6118426 | September 2000 | Albert et al. | 345/107 |
| 6124851 | September 2000 | Jacobson | 345/206 |
| 6136468 | October 2000 | Mitchel, Jr. et al. | 429/110 |
| 6225740 | May 2001 | Tucker et al. | 313/506 |
| 6439785 | August 2002 | Liu | 400/472 |

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

1. Field of the Invention

The present invention relates to a light emitting electroluminescent (EL) display device, and more particularly pertains to a light emitting electroluminescent display device with multiple animation configurations of a graphic and/or text design.

2. Description of the Related Art

The development of electroluminescent display devices of various types and purpose has been rapid in recent years.

Electroluminescence is currently used in a backlight function for computer screens, mobile phones, vehicle dashboards, etc. Electroluminescence is also used for novelty applications such as signs, nightlights, kites, wearable badges, and other items.

By way of example, U.S. Pat. No. 4,637,148 to Barlow; U.S. Pat. No. 5,013,967 to Hirotaka et al., U.S. Pat. No. 5,947,584 to Passanante et al.; U.S. Pat. No. 6,124,851 to Jacobson; U.S. Pat. No. 6,283,414 to Quinones; U.S. Pat. No. 6,302,559 to Warren; U.S. Pat. No. 6,424,088 to Murasko; and U.S. Pat. No. 6,439,785 to Liu demonstrates the variety of applications

While these devices fulfill their respective particular objective and requirements, the aforementioned patents, and cited U.S. patent and foreign patent references, do not describe an electroluminescent display device that animates a graphic and/or text design with multiple animation configurations.

In this respect, the animated electroluminescent display device according to the present invention substantially departs from the conventional concepts and designs of the prior art, and in doing so provides an apparatus developed for the purpose of animating electroluminescent graphic and/or text designs with multiple animation configurations.

Therefore, as there already exist a variety of electroluminescent display devices, none of which animate a display lamp with multiple animation configurations, it is evident that an improved device that animates the electroluminescent graphic and/or text designs with multiple animation configurations will be greatly valued.

### BRIEF SUMMARY OF THE INVENTION

The present invention has been implemented in view of the lack of animated electroluminescent display devices with multiple animation configurations, such that: there is an electroluminescent display device as described in claim 1 that contains a design in a layered substrate which includes electroluminescence, said design having transparent and uni-colored or multicolored elements; and, as described in claim 2, circuitry connected to a power source carries the electric charge to a varied number of contact points which connect with the different graphic and/or text design element(s) to be illumined with multiple animation configurations; and as further described in claim 2, there is a means for opening and closing the electrical circuit(s) that contact the different graphic and/or text design element(s) to be illumined with multiple animation configurations; and the electric charge can illumine any and all design element(s) in any selected simple or complex pattern such that the graphic and/or text design is animated with multiple animation configurations when the different electroluminescent graphic and/or text design element(s) is/are illumined.

Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. For example, the electroluminescent display device described in claim 1 can be of varying shape; of varying size; adapted to fit on or in various pieces of utilitarian equipment such as a computer, a mobile phone, or keyboards of various types; adapted to fit on or in various pieces of decorative products such as concert and sports novelties, vehicle decorations, or picture frames; and could be produced as a complete unit such as a badge worn on a hat or jacket. Further, different methods of production could also cause an adjustment to the particular description herein, as for example, as depicted in claim 1 regarding the construction of the electroluminescent display device, if lamination is used instead of plastic substrate, then the number of substrate necessary might be different than described herein. Still further is the potential application of different materials which might result in a variation of the description herein, as organic electroluminescence (OEL) could be substituted for electroluminescence (EL). Finally, variations regarding the source of power might result in still other aberrations of the described device, such that solar power or even other sources of power as yet unknown today might be used to power the described device in the future.

It is important, therefore, that the claims be regarded as including such equivalent adaptations and constructions insofar as they do not depart from the spirit and scope of the present invention.

Furthermore, it is an object of the present invention to provide a new and improved electroluminescent display device that has all the advantages of the prior art and none of the disadvantages.

It is another object of the present invention to provide a new and improved electroluminescent display device that may be easily and efficiently manufactured and marketed.

It is a further object of the present invention to provide a new and improved electroluminescent display device that is of durable and reliable construction.

An even further object of the present invention is to provide a new and improved electroluminescent display device that can be manufactured at a low cost with regard to both materials and labor, and which accordingly will allow low prices of the device in its various forms to the consuming public, thereby making such an electroluminescent display device in its various forms economically available to the buying public.

### BRIEF DESCRIPTION OF THE SEVERAL VIEWS OF THE DRAWING

The present invention may be further described with reference to the accompanying drawings, in which:

FIG. 1 is the exploded view of the electroluminescent display device described in claim 1.

FIG. 2 is the vertical view of the electroluminescent display device described in claim 1.

FIG. 3 is the vertical view of the electroluminescent display device described in claim 1, but in a round form to visually represent an alternative shape variation.

FIG. 4 is the vertical view of the electroluminescent display device described in claim 1, with the vertical view of the circuitry described in claim 2 FIG.

FIG. 5 is the bottom view of the electroluminescent display device described in claim 1, also showing a possible variation of the circuitry's connection to the electroluminescent graphics and/or text design element(s) to be illumined with multiple animation configurations.

### DETAILED DESCRIPTION OF THE INVENTION

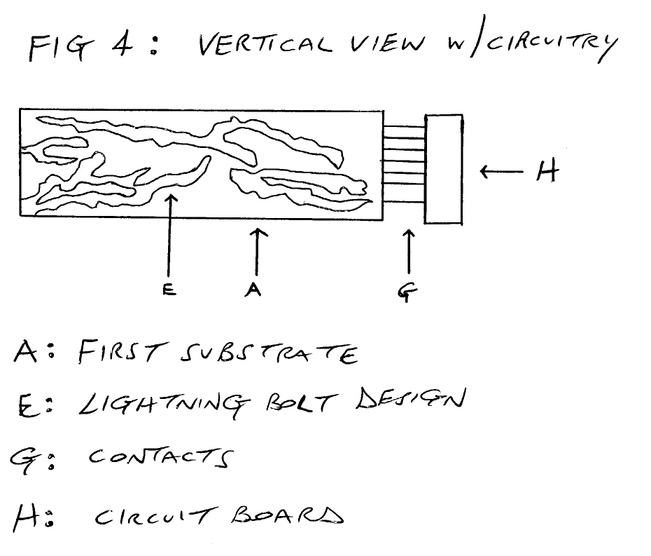

Referring now to the figures, the electroluminescent display device in accordance with the present invention is shown generally in FIG. 4.

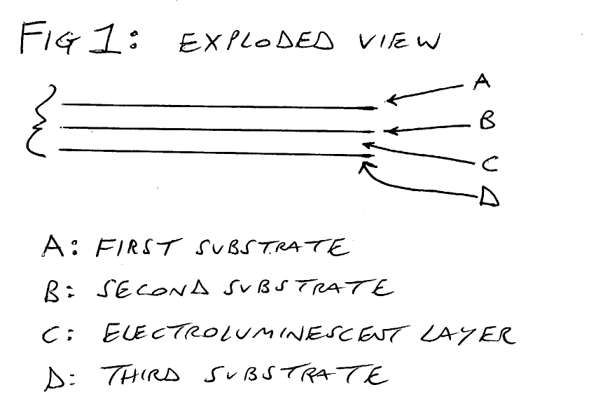

FIG. 1: The first substrate of clear plastic is (A). The second substrate is (B); this substrate contains the design with the design's colors and transparencies. In between substrate (B) and (D) is (C) the electroluminescent layer with the electroluminescence placed such that the electroluminescence fills the transparent design elements intended for illumination in the second substrate's variable unicolor or multicolor design graphic and/or text. The third substrate is (D). All three substrates are joined, enclosing the electroluminescent layer (C) within. While length and width are variable and dependent on the dimensions of the display, the electroluminescent device's depth is very thin and virtually no thicker than a fingernail.

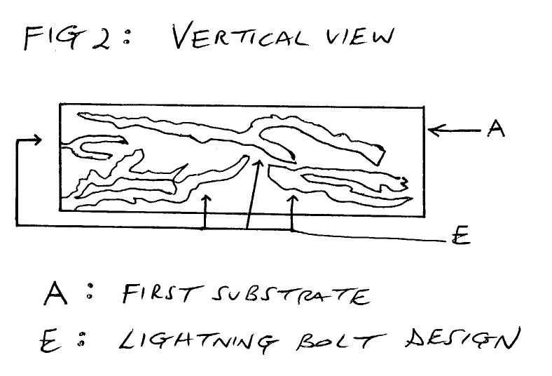

FIG. 2: This is a vertical view of the electroluminescent display device representing, for illustration's sake only, an example of a lightning bolt design (E) that would he illumined with multiple animation configurations when the electric circuits described in claim 2 open and allow the graphic elements to be illumined. FIG. 2 is black and white only, and while the electroluminescent display device can be unicolor, it is additionally intended to be multicolor when so specified.

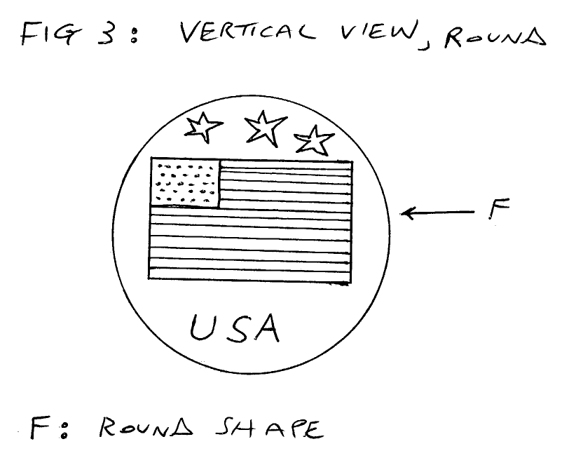

FIG. 3: As mentioned previously in the Brief Summary Of The Invention, the electroluminescent display device can be varied in many ways, and can assume different shapes. In this case, the electroluminescent display device is depicted in a round shape (F), and for illustration's sake only, an example of a U.S.A. Flag with Stars design is represented, which could be illumined with multiple animation configurations when the electric circuits described in claim 2 open and allow the graphic elements to be illumined.

FIG. 4: This is the most generally complete view of the electroluminescent display device. (A) is the same vertical view of the electroluminescent display device representing the lightning bolt design (E) in FIG. 2. (G) are the contacts linking the electroluminescent display described in claim 1 with the circuitry described in claim 2. (H) is the circuitry board with mounted circuitry and connections to the power source also as described in claim 2.

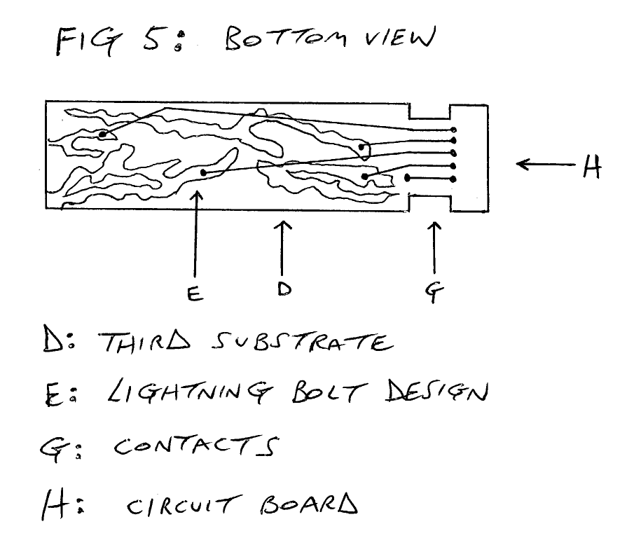

FIG. 5: In this Figure, the bottom view of the electroluminescent display device is visible, and represents the connection between the design elements intended for illumination, and, for illustration purposes only, the individual circuitry contacts for each of the different electroluminescent graphic design elements to be illumined with multiple animation configurations.

1. A light emitting electroluminescent (EL) display device containing:
a first substrate of clear plastic;
a second substrate below and joined to the first substrate, and containing a variable unicolor or multicolor design graphic and/or text made such that design element(s) intended for illumination are transparent;
a third substrate below and joined to the second substrate; and
an electroluminescent layer between the second substrate and the third substrate, with the electroluminescence placed such that the electroluminescence fills the transparent design elements intended for illumination in the second substrate's variable unicolor or multicolor design graphic and/or text.

2. The light emitting electroluminescent (EL) display device according to claim 1,
wherein the electroluminescent display device comprises:
contact means with a power source for providing a continuous electrical circuit;
circuitry sufficient to carry the electrical charge to the electroluminescent layer;
individual circuitry contact with each of the different electroluminescent graphic and/or text design element(s) to be illumined;
a means for opening and closing the electrical circuit(s) of the different graphic and/or text design element(s) to be illumined; and
a means for opening and closing the electrical circuit(s) of the different graphic and/or text design element(s) to be illumined allowing multiple animation configurations either individually, or all at once, or in any sequential or non-sequential pattern, or in any simple or complex pattern as designated by the graphic and/or text designer such that the electroluminescent display device's graphic and/or text design is animated when the electrical circuit is energized and complete.
